(19) United States
(12) Patent Application Publication
(10) Pub. No.: US 2015/0213725 A1
(43) Pub. Date: Jul. 30, 2015

(54) METHOD, APPARATUS, AND SYSTEM FOR VIEWING MULTIPLE-SLICE MEDICAL IMAGES

(71) Applicant: TRACTUS CORPORATION, Danville, CA (US)

(72) Inventors: Scott P. Huntley, Danville, CA (US); Bruce A. Robinson, Maple Valley, WA (US); Philip E. Eggers, Amelia Island, FL (US); Eric A. Eggers, Portland, OR (US); Gerald R. Kolb, Bend, OR (US)

(21) Appl. No.: 14/424,287

(22) PCT Filed: Aug. 28, 2013
(86) PCT No.: PCT/US13/56930

§ 371 Date: Feb. 26, 2015

Related U.S. Application Data
(60) Provisional application No. 61/698,192, filed on Sep. 7, 2012.

(51) Int. Cl. G09B 5/02; G06F 3/01

(52) U.S. Cl. CPC G09B 5/02; G06F 3/013; G06F 3/015; G06F 3/011

(57) ABSTRACT

Systems and methods are disclosed for reviewing multiple images while monitoring a reviewer's attentiveness during the review. Systems include an image review system configured to output a series of images to the display and a user attention monitoring system configured to monitor at least one attention parameter for a user during the user's review and to generate user attention data based on the at least one attention parameter monitored, wherein the image review system is configured to output the second image to the display if the user attention data indicates sufficient user attentiveness. The image review system may also be configured to generate distraction or review breaks during the review period.

### CROSS REFERENCE TO RELATED APPLICATIONS

This application claims the benefit of U.S. Patent Appl. No. 61/698,192, titled “Method, Apparatus, and System for Viewing Multiple-Slice Medical Images”, filed Sep. 7, 2012, the disclosure of which are incorporated herein by reference.

### INCORPORATION BY REFERENCE

All publications and patent applications mentioned in this specification are herein incorporated by reference to the same extent as if each individual publication or patent application was specifically and individually indicated to be incorporated by reference.

### FIELD

Embodiments described relate generally to multiple image review systems including attention monitoring options for facilitating attentive and focuses review of medical images.

### BACKGROUND

Medical imaging is typically referred to as Radiology because of the historical use of radiation-based imaging techniques to view internal structures of the human body. The origin of radiology is traditionally credited to Wilhem Rontgen, a German Physicist who discovered X-radiation (electromagnetic radiation in the 0.01 to 10 nanometers and with an energy levels ranging from 100 eV to 100 KeV) in 1895 as a result of his research on cathode ray tubes. Dr. Rontgen discovered that radiation emitted from the cathode ray tubes could pass through some forms of human tissue with varying degrees of absorption and that the X-radiation could expose photographic film. One of his first experiments was the now famous image of his wife's hand showing the bones of the hand with her wedding ring suspended as a halo around the proximal phalange of the third finger. The medical implications of viewing internal body structures were apparent and Dr. Rontgen was awarded the Nobel Prize for Physics in 1901.

As technology modifications of the applications of X-radiation and the introduction of other forms of imaging, such as Computed Tomography (CT, or “CAT scan”) and Magnetic Resonance Imaging (MRI). Many of these advances changed the presentation of these images from that of a single, “still” image to the presentation of a sequence of images.

In the case of the CT, X-radiation images are presented as a series of still “slices” of the body, each slice offset by a physical distance. In other words, the CT presents a series of cross-sectional slices of a part of the body (for example, the head and brain) that are viewed one at a time, in sequence. The MRI images also present a series of still slices, but use a different method of imaging the tissue (the magnetic signature of the tissue rather than the absorption of X-radiation). The effect of viewing these images, from the viewer's perspective, is to pass through the anatomic structure.

Time-based sequences may differ from space-based sequences in that the viewer observes a single structure, but observes changes in that structure based on time. A common application of viewing time-based sequences is to view the changes in concentration of contrast agents that are injected into the blood stream. In some cases multiple images are obtained so that the single image with maximum contrast may be singled out, and in other cases the dynamic changes in the concentration of the contrast agent are indicative of certain medical conditions.

U.S. Pat. No. 6,067,075 describes the advantages of viewing medical images, such as cardiac catheterization X-ray images, as a set of sequential images because it is not always possible to predict the exact moment to obtain the optimal still image (such as when the contrast agent is at its maximum concentration in the arteries).

The earliest methods of viewing these multi-planar or time-based sequences were to present them as a set of individual transparencies that were viewed on a traditional radiology viewer (that is, a back-lit display upon which film transparencies were hung). With the advent of digital imaging it is possible to present these sequential images one at a time on a viewing monitor, rather than as a set transparencies viewed all at once.

In the digital environment the observer can view each image sequentially. This can be accomplished by manually commanding the display to discard one image and present the next, or the imaging program can automatically present each sequential image according to some pre-determined timing interval. The predetermined sequential presentation of still images is the basis for the motion picture, or cine, and has been a common method for displaying everyday images for more than a century. In medical imaging, however, its use in medicine has been employed routinely during the past two decades.

As sequential imaging technology has evolved, so, too, have the number of images presented. The original CT scanners provided 4 slices. In 2012 the standard is 64 slices and there are 256 slice systems in development. Recorded ultrasound studies can often involve many thousands of slices.

In this environment the dwell time, or speed at which the sequential images are presented before the next image is displayed, can become critical. Radiology reading time is critical to the financial and operational efficiency of any radiology practice, so it is optimal to reduce the dwell time (i.e., increase the speed) of the presentation of the images.

There is a dwell time, or speed, at which the human mind changes its interpretation of the sequential presentation of images from that of viewing a series of individual images, to the presentation of a motion picture, or cine. If the dwell time is less than 1/15^{th} of a second (12 frames-per-second (fps)) the human eye ceases to distinguish between individual images and perceives “motion”. As described in Read P and Meyer P, Restoration of Motion Picture Film, Gamma Group, ISBN 0-7506-2793-X, pp 24, “The human eye and its data reception and transmission system can from, transmit and analyze 10⁻¹² images per second. The vision centre in the brain retains each individual image for one-fifteenth of a second. If the vision centre in the brain receives another image during this fifteenth of a second, the sight mechanisms will create the sensation of visual continuity.” Most motion pictures present images at 24 fps or greater.

Additionally, in some cases the human eye and mind can interpret sequential image presentation as having the illusion of motion. That is, the images do not show actual motion, but may show different aspects of the same area, subject, etc. that is more or less stationary. The different aspects shown may include images with different cross-sections, magnification, and angles. The illusion of motion may be perceived by human vision by displaying images at a rate of 6 frames per second or more.

This perception of motion is actually critical to human vision and the perception of objects. The human eye can only see objects which are “moving” and the eye continually moves so that even stationary objects appear to “move” from the perspective of the observer. When the eye is forced to be stationary then objects which are also stationary actually disappear from the human perspective. This phenomenon is further described in Martinez-Conde S, Macknik S L, and Hubel D H, The Role of Fixational Eye Movements in Visual Perception, Nature Reviews, Neuroscience, Volume 5, March, 2004, The Nature Publishing Group, pp 229-240.

The human eye and the human brain have completely different mechanisms for processing image information and size and shape information. The result is that the human mind uses two completely different mechanisms to perform detection or screening function, than it does to perform descriptive, or analytic functions (diagnostic).

As a result, it is easier for the human mind to detect abnormal objects when they are presented in an environment where there is some aspect of motion, than it is to detect that abnormality when the object is still, but it is easier to analyze the nature of that object when it is not moving than it is to analyze that object when it is in motion. An example from nature is the case when a lion is stalking its prey. It is difficult to see the camouflaged lion in the background of high brown grass, but it is easier to see that lion when it is moving through the grass (detection). Once detected, however, and the viewer knows where to look, it is easier to characterize the lion (old or young?, male or female?, etc.) when the lion is still. Bollmann, et al. describe the role of motion in visual attention (motion) at Bollman M, Hoischen R, and Mertsching M, “Integration of Static and Dynamic Scene Features Guiding Visual Attention”, in Paulus, E.; Wahl, F. M. (eds.): Mustererkennung 1997. Berlin et al. (Springer) 1997, pp. 483-490. Krupinksi described this same effect in medical imaging when she presented data showing that it is easier to detect abnormalities in cardiac catheterization procedures when the images are rotated, giving the illusion of motion. Elizabeth Krupinski, PhD, University of Arizona Presentation at the 2006 Society for Imaging Informatics in Medicine.

That illusion of motion is replicated in the “moving” picture. If a CT or ultrasound takes several slices of different portions of a physical structure then the sequential presentation of those images gives the effect that the viewer is “moving” through that structure. If the structure were a perfect sphere then it would start as a small circle, grow larger to a maximum, and then decrease to a small circle again. For that “motion” illusion to be optimized, however, then the frame rate of the presentation must be such that the mind perceives the sequential presentation of the images as “motion”. As described earlier, that speed may be in excess of 6 fps, perhaps in excess of 12 fps or 20 fps.

Both of these factors, the desire to reduce review time and the desire to optimize the advantages of viewing images in motion, suggest that increasing frame rate is a useful implementation of the presentation of sequential images. In some cases, increasing frame rate to a maximum rate allowed by hardware may be desired to optimize the review process. However, two limitations on increasing frame rates are the reduced ability of the mind to process the anomalies as they are presented and the information that is lost to the viewer in the form of frames that are displayed during the blinking process or because of attention distraction issues.

For example, the dynamics of viewing medical images in a screening process differ dramatically from viewing them in a diagnostic process. In a diagnostic procedure the viewer is, by definition, examining a known entity in an attempt to characterize it. For example, in breast radiology a patient presenting with a cluster of microcalcifications, or an asymmetric density, or a mass on her screening mammogram is known to have a cluster of microcalcifications, or an asymmetric density, or a mass on her screening mammogram. In the diagnostic exam the physician reviews those anomalies in detail, but the physician only reviews those anomalies, he or she is not responsible for interpreting features that are outside the region of the previously identified anomaly. In addition, because the anomaly has been previously identified, the clinical personnel expect to find that anomaly during the diagnostic exam.

Screening exams are performed on people who are presumed to be healthy. Therefore, the clinical personnel expect to find nothing at all. For instance, in breast radiology every 1,000 screening mammograms read only three or four cancers are identified. Fewer than 100 suspicious lesions are identified. Thus, 90% of the image sets reviewed are “nothing” and look like “nothing”, 9.6% are “nothing” but look like “something”, and only 0.4% are actually something which turns out to be cancer.

Viewing multiple image sets, most of which contain nothing that will draw the reviewer's attention, can become monotonous. Monotony can lead to loss of attention, and loss of attention can result in the reviewer missing actual regions of concern. This concern is amplified when viewing images in rapid succession (i.e. viewing the video). With still images the viewer can avert her attention from the image and return and refocus without losing information. With video lost attention means lost information.

There is a limit, however, in how long a human being can provide “focused” attention to a video event without some pause for distraction. The ability to sustain focused attention may be as short as 8 seconds. The longer one requires focused attention the more anxiety the subject experiences or the greater the opportunity for distraction. Reducing monotony-related distractions is on reason that traffic engineers design curves in to roadways that could otherwise be straight.

One solution to this issue in the field of video viewing is to introduce distractions. Common methods for this are scene changes, rapid plot changes (such as comic relief) or outright cessation of the viewing experience (intermission, or commercials).

If the frequency of such a pause is known, it will allow the viewer to better ignore distractions in the viewing experience. Anecdotally, most people have experienced this phenomenon in everyday life. When one is interrupted when watching a television show, or talking on the telephone, it is easier to ignore the interruption and pay full attention to the initial activity if the participant knows that a break in that initial activity will occur within a short period of time. If the participant is not sure when the break is coming, or if it is known that the break will be long, the participant is distracted. Since the ability to sustain focused attention is approximately 8 seconds, it is the hypothesis of this teaching that breaks in the viewing experience should occur every 10 seconds to 20 seconds.

If the breaks in the viewing experience exceed that time, then the experience quality will suffer, or the expectations of the experience must be decreased. A specific example of this effect is the video viewing rate. If the video is presented in small segments, for example less than 10 seconds, then it may be presented rapidly because the viewer is able have focused attention on that video. If the video is presented in extended periods then the viewer will exceed the focused attention time span and will not be able to concentrate on the rapid video presentation.

In addition, screening examinations involve the unknown and that, in itself, can add to the stress of the work situation. Hancock suggests that, rather than being understimulating, vigilance tasks are exacting, capacity-draining assignments that are associated with considerable levels of stress in which the quality of performance efficiency wanes over time. Hancock, Pa. and Szalma J L, Performance Under Stress (Human Factors in Defense), Ashgate, Jan. 1, 2008, ISBN-13=978-0754670599. Thompson and McCreary describe how Temporal Uncertainty (not knowing when an event is going to happen) and Ambiguity (lack of situational clarity) can decrease feelings of control. Thompson, M. M.; McCreary, D. R. (2006) Enhancing Mental Readiness in Military Personnel. In Human Dimensions in Military Operations—Military Leaders' Strategies for Addressing Stress and Psychological Support (pp. 4-1-4-12). Meeting Proceedings RTO-MP-HFM-134, Paper 4. Neuilly-sur-Seine, France: RTO. Available from: http://www.rto.nato.int/abstracts.asp. This impact increases when the event is imminent. Sime described that stress arising from emergency situations that are rarely and infrequently encountered can be reduced by introducing simulated scenarios, such as case studies of past incidents. In addition to reducing stress, the use of case study training can increase confidence, which also increases performance. Sime J, “Designing Emergency Response Training: Seven Ways to Reduce Stress”, AIADIS International Conference on Cognition and Exploratory Learning in Digital Age (CELDA 2007), ISBN: 978-972-8924-48-5 © 2007 IADIS.

Sime summarized Spiro and Jehng's proposed the Cognitive Flexibility Theory (CFT) as a method of developing flexible reasoning patterns that are capable of dealing with novelty in situations. Specifically, they suggest that simulated scenarios, such as case studies of past incidents, in an interactive simulation can reduce stress of the unknown and increase confidence in dealing with an emergency. In addition, attention may be heightened by informing the reviewer that known findings will be presented during the review process. Hancock and Szalma describe that providing a cue of an imminent event served to increase engagement in the process (that is, attention). Hancock also describes that events which force the operator to re-engage process decreases stress and increases performance.

The introduction of simulated case studies is the equivalent of unscheduled General Quarters drills on shipboard during the Second World War. These drills, designed to “keep them on their toes” were a proven method of maintaining alertness during what was otherwise a monotonous lifestyle.

As such, embodiments described provide for attention monitoring systems, devices, and methods that address at least these concerns posed by information loss during the review of medical images.

### SUMMARY OF THE DISCLOSURE

Aspects of the invention relate to a system for reviewing multiple images that includes a display; a user attention monitoring system configured to detect at least one attention parameter for a user in proximity to the display, wherein the attention monitoring system generates user attention data based on the at least one attention parameter detected; and an image review system in communication with the attention monitoring system, the image review system configured to output a first image and a second image to the display, and the image review system configured to access the user attention data generated by the attention monitoring system prior to outputting the second image to the display, wherein the image review system outputs the second image to the display if the user attention data indicates sufficient user attentiveness.

In some embodiments, the image review system is configured to output the second image to the display only if the user attention data generated by the attention monitoring system indicates sufficient user attentiveness.

In other embodiments, the image review system is configured to access the user attention data generated by the attention monitoring system prior to outputting the first image to the display, and wherein the image review system is configured to output the first image to the display if the user attention data indicates sufficient user attentiveness.

In other embodiments, the attention monitoring system is configured to detect the at least one attention parameter and generate the user attention data independently of the operation of the image review system.

In other embodiments, the image review system is configured to display the first and second images at an image display rate. In some cases, the image review system is configured to receive the image display rate as a user input value. In additional variations, the image display rate is measured as a region reviewed per second. In any of the preceding embodiments, the image display rate is at least about 6 frames per second.

In any of the preceding embodiments, the image review system is configured to calculate a first image dwell time for the first image and a second image dwell time for the second image based on the image display rate.

In any of the preceding embodiments, the image review system is configured to calculate the first and second image dwell times based on a scan distance between the first and second images. In any of the preceding embodiments, the image review system is configured to display the first image for at least the first image dwell time and the second image for at least the second image dwell time.

In any of the preceding embodiments, the image review system is configured to display the first image for a first dwell time and the second image for a second dwell time.

In any of the preceding embodiments, the image review system is configured to access the user attention data generated by the attention monitoring system prior to displaying the second image for a second dwell time.

In any of the preceding embodiments, the image review system is configured to display the first image for a residual display period prior to displaying the second image.

In any of the preceding embodiments, the attention monitoring system comprises an attention detection device configured to detect the at least one attention parameter for the user.

In any of the preceding embodiments, the attention monitoring system comprises a controller configured to generate the user attention data based on the at least one attention parameter detected.

In any of the preceding embodiments, the attention monitoring system is configured to continuously detect the at least one attention parameter for the user during the multiple image review.

In any of the preceding embodiments, the image review system is configured to dynamically increase an image display rate for a series of images output to the display based on the user attention data.

In some embodiments the user may adjust the display rate faster or slower. In some cases, the adjusted display rate is then constant unless further adjusted.

Other aspects of the invention relate to a system for reviewing multiple images including a display; an image review system configured to output a series of images to the display, the series of images comprising at least a first image and a second image; and a user attention monitoring system in communication with the image review system.

In some embodiments, the attention monitoring system includes an attention detector device configured to monitor at least one attention parameter for a user during the user's review of the first image on the display, wherein the attention detector device generates a first set of user attention data based on the at least one attention parameter monitored during the user's review of the first image; a controller in communication with the attention detector device, the controller configured to electronically receive the first set of user attention data from the attention detector device and electronically communicate the first set of user attention data to the image review system, wherein the image review system is configured to output the second image to the display if the first set of user attention data indicates that the user was sufficiently attentive when reviewing the first image.

In any of the preceding embodiments, the image review system is configured to display the series of images at an image display rate. In any of the preceding embodiments, the image display rate is a user defined image display rate and the image review system is configured to receive input of the user defined image display rate. In any of the preceding embodiments, the image display rate is measured in region reviewed per second. In any of the preceding embodiments, the image display rate is at least about 6 frames per second.

In any of the preceding embodiments, the image review system is configured to display the first image for a first dwell time and the second image for a second dwell time. In any of the preceding embodiments, the image review system computes the first and second dwell times based on an image display rate. In any of the preceding embodiments, the controller of the user attention monitoring system is configured to generate the first set of user attention data based on monitoring the at least one attention parameter during the first dwell time, and the controller is configured to generate a second set of user attention data based on monitoring the at least one attention parameter during the second dwell time.

In any of the preceding embodiments, the image review system is configured to dynamically increase an image display rate for the series of images based on the first set of user attention data.

In any of the preceding embodiments, the image review system is configured to display the second image if the first set of user attention data satisfies attention limit values stored by the image review system. In any of the preceding embodiments, the first set of user attention data satisfies the attention limit values if the first set of user attention data does not exceed the attention limit values. In any of the preceding embodiments, the attention limit values are user defined limit values.

In any of the preceding embodiments, the at least one attention parameter comprises an ocular parameter. In any of the preceding embodiments, the ocular parameter comprises eye position. In any of the preceding embodiments, the ocular parameter comprises eye closure. In any of the preceding embodiments, the ocular parameter comprises eye movement. In any of the preceding embodiments, the at least one attention parameter comprises head position. In any of the preceding embodiments, the at least one attention parameter comprises brain wave activity.

In any of the preceding embodiments, the attention detection device is configured to monitor the at least one attention parameter during the user's review of the second image, the attention detector device adapted to generate a second set of user attention data based on the at least one attention parameter monitored during the user's review of the second image; and the controller configured to electronically receive the second set of user attention data from the attention detector device and electronically communicate the second set of user attention data to the image review system, wherein the image review system is configured to output a third image of the series of image to the display if the second set of user attention data indicates that the user was sufficiently attentive when reviewing the second image.

In another aspect, embodiments provide for a system for reviewing multiple images including a display and an image review system configured to output a series of individual images to the display, wherein the image review system is configured to generate at least one distraction break during a user's review of the series of image on the display.

In any of the preceding embodiments, the at least one distraction break comprises stopping the output of the series of individual images to the display. In any of the preceding embodiments, the at least one distraction break comprises pausing the output of the series of individual images to the display and presentation of a teaching case to the user.

In any of the preceding embodiments, the image review system comprises a plurality of stored teaching cases and the image review system is configured to populate a worklist of teaching cases for presentation to the user during the user's review of the series of individual images. In any of the preceding embodiments, the at least one distraction break comprises presenting at least one teach case from the worklist of teaching cases to the user during the user's review of the series of individual images.

In any of the preceding embodiments, the multiple image review system including an attention detector device configured to monitor at least one user attention parameter during the user's review of the series of individual images.

In another aspect, embodiments provide for a method of displaying multiple images including the steps of displaying a first image stored in an image review system on a display for at least a first dwell time; detecting at least one user attention parameter for a user with a detection device during the first dwell time; generating a first set of user attention data from the detection device based on the at least one user attention parameter monitored during the first dwell time; and electronically communicating the first set of user attention data to the image review system, wherein the image review system displays a second image if the first set of user attention data indicates the user was attentive during the first dwell time.

In any of the preceding embodiments, the method may include the step of displaying a second image on the display for at least a second dwell time; detecting the at least one user attention parameter for the user during the second dwell time; generating a second set of user attention data from the detected user attention parameter; electronically communicating the second set of user attention data to the image review system, wherein the image review system displays a third image if the second set of user attention data indicates the user was attentive during the second dwell time; and displaying a third image on the display for at least a third dwell time.

In any of the preceding embodiments, the method may include the step of receiving an image review rate for reviewing a plurality of images on the display, wherein the plurality of images comprises at least the first image; and computing a dwell time for each image of the plurality of images based on the image review rate and the number of images in the plurality of images.

In any of the preceding embodiments, the image review rate is a region reviewed per second rate.

In any of the preceding embodiments, the method may include the step of monitoring the user's attentiveness during the user's review of a plurality of images on the display; and dynamically modifying an image review rate for a plurality of images based on the monitoring step.

In any of the preceding embodiments, wherein detecting at least one user attention parameter for a user during the first dwell time comprises detecting the at least one user attention parameter multiple times during the first dwell time.

In any of the preceding embodiments, the image review system is configured to determine the user's attentiveness during the first dwell time by comparing the first set of user data to stored attention limit values in the image review system.

In any of the preceding embodiments, the method may include the step of displaying the first image for a residual dwell period, wherein the residual dwell period occurs after the first dwell time has lapsed; detecting the at least one user attention parameter for the user during the residual dwell period; generating a residual set of user attention data from the at least one user attention parameter monitored during the residual dwell period; and displaying a second image if the residual set of user attention data indicates the user was attentive during the residual dwell period.

In another aspect, embodiments provide for a method for reviewing multiple images including the steps of displaying a series of individual images on a display; generating at least one distraction break by a controller configured generate the at least one distraction break during the display step.

In any of the preceding embodiments, wherein the at least one distraction step comprises pausing the display step and presenting a teaching case on the display.

In any of the preceding embodiments, wherein the at least on distraction step comprises automatically pausing the display step at a predetermined period of time.

In any of the preceding embodiments, the method includes the step of generating a case worklist from a plurality of teaching cases stored in a controller; presenting at least one case in the case worklist to the user on the display; and presenting teaching points to the user on the display for the at least one case presented to the user.

In another aspect, embodiments provide for a method of displaying multiple images including the steps of detecting at least one user attention parameter for a user with a user attention monitoring system; generating user attention data with the user attention monitoring system based on the at least one user attention parameter; displaying a first image stored in an image review system on the display; and electronically accessing the generated user attention data by the image review system prior to displaying a second image stored in the image review system on the display, wherein the second image is displayed on the display if the accessed user attention data indicates sufficient user attentiveness.

In any of the preceding methods, the steps may include receiving a frame rate; and calculating a first image dwell duration for the first image and a second image dwell duration based for the second image based on the received frame rate; and displaying the first image on the display for the first image dwell duration.

In any of the preceding methods, the steps may include the electronically accessing step occurring after the end of the first image dwell duration.

In any of the preceding methods, the steps may include electronically accessing the generated user attention data by the image review system prior to displaying the first image stored in the image review system on the display, wherein the first image is displayed on the display if the accessed user attention data indicates sufficient user attentiveness.

In any of the preceding methods, the steps may include the detecting and generating steps continuously performed independent of the displaying step.

In any of the preceding methods, the steps may include displaying the first image on the display for a residual period after the end of the first image dwell duration.

In any of the preceding methods, the steps may include the electronically accessing step comprising querying the user attention monitoring system for an attention status indicator, and wherein the second image is displayed on the display if the attention status indicator indicators sufficient user attentiveness.

In any of the preceding methods, the steps may include querying the user attention monitoring system more than once for an attention status indicator prior to displaying the second image to the display.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1A shows a system for reviewing multiple images.

FIG. 1B shows a multiple image review system with an attention monitoring system and an image review system.

FIG. 2A is a flowchart showing a method for displaying images and monitoring attentiveness.

FIG. 2B is a flowchart showing a method for displaying images while monitoring attentiveness.

FIG. 3 is a flowchart showing an alternative method for displaying images.

FIG. 4 is a flowchart showing a method for monitoring the attentiveness of a reviewer and displaying multiple images with respective dwell times.

FIG. 5 is a flowchart showing a method for displaying of multiple images while monitoring user attentiveness.

FIG. 6 shows a multiple image review system configured to generate at least one distraction or review break.

FIG. 7 is a flowchart showing a method of presenting teaching cases during multiple image review.

### DETAILED DESCRIPTION

In one aspect, embodiments of the invention provide methods, devices, and systems for monitoring the attention of a viewer during the presentation of a sequence or series of medical images. The medical images may be presented as individual images or as a cine or motion picture display. Additionally, the attention monitoring systems, devices, and methods may be used to minimize, reduce, or eliminate information loss during, for example, an eye blink, looking away from a display, and any other type of attention distraction. Moreover, the contemplated embodiments may also reduce stress and increase focused attention during a review process.

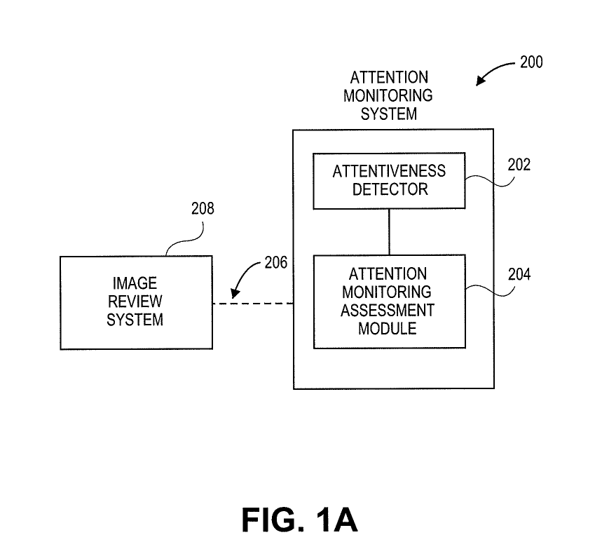

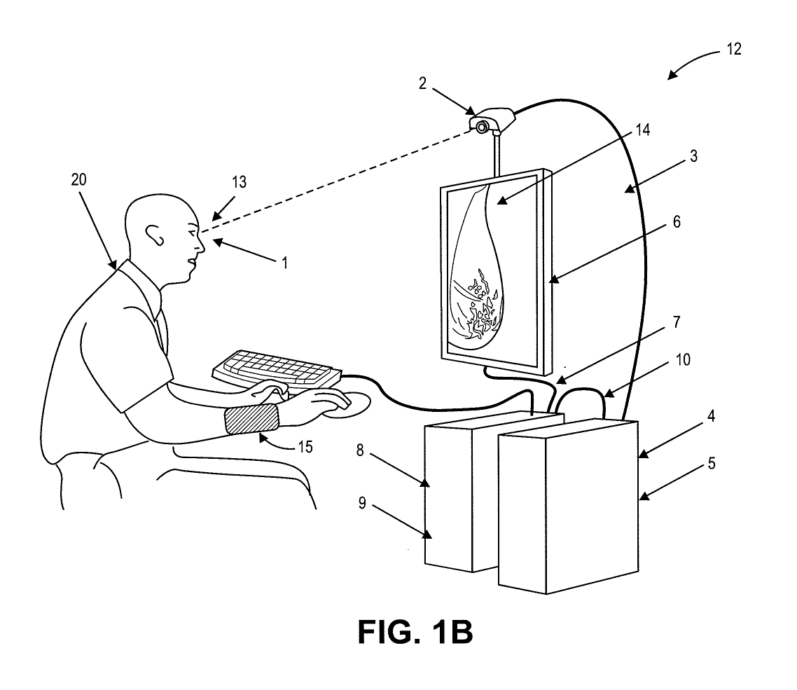

Referring to FIG. 1A, in one embodiment, the system for viewing multiple images generally includes a first subsystem 208 that is an image review system having a data storage device or means to store image files. The image review unit/system may be configured to control the output of a series or sequence of images, such as medical images, to a display (e.g. display monitor). The output of the images may be controlled in terms of the rate at which a series of images is displayed and/or the duration each image is displayed on a monitor.

The image review unit/system may also output the images to the display according to a user selected image display rate or other criteria. For example, the user may desire to review images at an image display rate of “X” frames per second. The “X” frames per second may be selected based on the user's desire to have a motion picture or cine type presentation of the images as is generally useful for a detection or screening function. Additionally, in the case of reviewing medical images from a medical scan of a patient, the user may desire to review images at a region reviewed per second rate. A region reviewed rate may in some cases provide the user with a similar review experience compared to the actual scanning procedure. For example, the user may select a region reviewed per second rate of 1 cm/sec that will show a series of ultrasound images in a presentation similar to what a technician sees during the scanning procedure. In some embodiments, the user can input or select a desired image display rate from the image review unit/system.

Additionally, in the course of the review process, the image review system may check on the status of a user's attentiveness. In some cases, the multiple image system includes an attention monitoring system 200 that monitors at least one attention parameter for a user reviewing images. The attention monitoring system 200 may include an attentiveness detector 202 that gathers or collects data or information for the at least one attention parameter before, during, or after the review process. For example, the attention monitoring system 200 may include a detector 202 adapted to monitor a location near a display where a user is expected to be during the review process. The detector 202 may capture images of the location near the display and output those images to an attention monitoring assessment module 204 of the attention monitoring system 200. The attention monitoring assessment module 204 may process the images to generate attentiveness data for the user. The attentiveness data may also include an attention status indicator and/or attentiveness level for the user. Additionally, the attention monitoring system may store the attentiveness data and/or status.

A user's attentiveness may be monitored, detected, or measured through any number of methods including monitoring a user's attentiveness parameter. Attentiveness parameters include ocular parameters such as the eye gaze direction, eye position, eye movement, eye blink, eyelid position, or pupil diameter. Other attentiveness parameters include, but are not limited to, brain wave activity data, facial movement data, heart rate, respiration rate, body movement, pulse, electroconductivity through skin etc.

Additionally, monitoring methods include those for detecting the presence of an eye blink or eye closure. Yamamoto described a drowsiness detector in 1990 (U.S. Pat. No. 4,953,111) as did Kumakura (U.S. Pat. No. 5,786,765), Galiana (U.S. Pat. No. 6,091,334), and Nagagoshi (U.S. Pat. No. 7,830,266), all of which are incorporated by references in their entirety. Other related eye detection methods are described in U.S. Pat. No. 5,410,376; U.S. Pat. No. 7,659,923; U.S. Pat. No. 7,676,063; U.S. Pat. No. 7,714,927; U.S. Pat. No. 8,203,599, all of which are incorporated by reference in their entirety.

As an example, the attention monitoring unit may include a camera that is directed toward an expected location for a user's eye during the user's review of images on a display. The camera takes images of the user's eye during the user's review of an image. The attention monitoring unit/system assesses the eye image to determine if the user is looking at the display and/or if the user's eyes are closed/open/blinking or gazing at something other than the display or the image.

In some cases, this attention assessment may be stored as attentiveness data such as a number on a scale of 1-10 where 1-5 indicates sufficient attentiveness and 6-10 indicate insufficient attentiveness. In other cases the scale may be adjusted to be more compatible with the binary nature of computer programming languages, such as 1-to-4, 1-to-8, 1-to-16, 1-to-32, 1-to-64, 1-to-128, 1-to-256, etc. Alternatively, the attentiveness data may be stored as a binary assessment of “yes” or “no” to a sufficient attentiveness query (e.g. 0, 1 bit). Additionally attentiveness data may be assessed by using: a Psychomotor Vigilance Performance Task; the Karolinska Sleepiness Scale, which assigns a numerical value to levels of sleepiness (1=extremely alert, 5=neither alert nor sleepy, and 9=extremely sleepy); a Visual Analogue Sleepiness Scale; and/or any acceptable scale that may be used in connection with evaluating head movement data, brain wave activity data, eye movement data, facial movement data and/or eye closure data etc. It may be desirable to configure the image review system to evaluate attentiveness data using other scales, as known to those skilled in the art.

In some cases, the attentiveness data is compared with attentiveness or attention limit values. The attentiveness limit values may be based on an attentiveness scale as described. For example, the limit value may be “5” based on the Karolinska Sleepiness Scale and the attentiveness data must be 5 or lower in order to satisfy the limit value. In other cases, the attentiveness data must be equal or greater than a limit value to indicate sufficient attentiveness. Alternatively, the attentiveness data must be equal to the limit value to indicate sufficient attentiveness.

In operation, the image review unit/system may access the attentiveness data and/or status generated by the attention monitoring system via a wired or wireless connection 206. In some cases, the image review system may query the attention monitoring system one or more times for the user's attentiveness status. For example, before displaying an image for the user's review, the image review system may electronically access the attentiveness data generated by the attention monitoring system. If the attentiveness data indicates that the user is sufficiently attentive, the image review system will output the first image to the display. When the image review system is ready to output a second image (or subsequent images) to the display but prior to displaying the second image, the image review system may check the attentiveness data generated by the attention monitoring system. If the attentiveness data indicates sufficient user attentiveness, the image review system will display the second image. In some cases, if the attentiveness data does not indicate sufficient attentiveness by the user, the image review system will stop the display of images; the image review system may stop or pause cine play or not advance to the next image until the attentiveness data shows sufficient attentiveness has been established and/or the user selects an option to continue review. For example, if the image review system is displaying 10 images at 10 images per second, the image review system may not display the second image until the image review system receives an indication from the attention monitoring system that the user is paying attention to the display and, therefore, will pay attention to the next image.

Advantageously, this attentiveness monitoring feature helps to reduce information loss that can occur from distraction during the review. For example, the average duration of a human eye blink is 100 ms to 400 ms. If the presentation of images is 24 fps, and if images continue to be presented when the eye is closed, then a blink could result in the observer missing 2 to 10 frames. In addition to losing some of the “motion” artifact that is key to a screening procedure, these lost frames could represent as much as 1 cm of tissue. This puts the ability to find sub-centimeter lesions at risk.

Additionally, although described as an image review system/unit and an attention monitoring system/unit, these two features may be part of a single system such as modules within a single computer or, alternatively, separated into two systems in separate computers or processors.

Moreover, the attention monitoring system and the image review system may operate independently of one another where the attention monitoring system detects the user's attention and generates attentiveness data separately from the operation of the image review system.

Referring now to FIG. 1B, a system for reviewing multiple images 12 is generally illustrated. The multiple image review system 12 includes an image review system (or unit) 8 and an attention monitoring system (or unit) 4. As shown, the image review system 8 is an ultrasound image review system configured to store and display ultrasound images 14. The ultrasound image review system 8 includes a computer or controller 9 that is in communication with a display 6 (e.g. one or more monitors). The display 6 displays ultrasound images 14 (which may be sequential or in a series). The display is also in communication with the ultrasound computer 9 through a cable 7.

Still referring to FIG. 1B, the ultrasound image review system 8 may control the display rate of the ultrasound images 14 on the monitor 6. In some cases, the ultrasound image review system 8 also controls the pause and play features for a motion picture or cine presentation of a series of ultrasound images. Additionally, the ultrasound image review system 8 may be configured to pause to select any single ultrasound image 14. Any of these features or other features of the ultrasound image review may be controlled by the software or hardware in the ultrasound image review computer 9.

As shown in FIG. 1B, the multiple image review system 12 includes an attention monitoring system or unit 4. The attention monitoring system 4 has a detector 2 that monitors at least one user attention parameter. The detector 2 is shown as a video camera that may continuously or discontinuously monitor the eye or eyes 1 of reviewer 20. The detector 2 communicates with an attention monitoring computer 5 via first cable 3. The attention monitoring computer 5 records the eye images (not shown) of detector 2 and a software algorithm incorporated in eye monitor computer 5 analyzes the recorded eye images (not shown) for the detection of an ocular parameter such as an eye blink, eyelid location, eye gaze direction, etc. of practitioner 20. Additionally, the detector 2 may detect more than one user parameter. For example, the detector may detect both facial movement and eye gaze direction.

In some cases, the detector 2 may generate images of an observation location or an area near the display 6 where the reviewer is expected to be during the review process. The detector 2 may also be configured to generate images of an area where a specific portion of the user's body is expected to be during the image review. For example, FIG. 1B shows the detector 2 directed toward the user's eye(s) 1. As such, the detector 2 generates images of the expected eye location 13.

In further variations, the attention monitoring system 4 may include other attentiveness detectors such as sensors 15 for detecting body movement, heart rate, respiration rate, blood pressure, or any other physiological parameters.

The attention monitoring system 4 may receive the detected user attention parameters and generate a set of attentiveness data based on the received detected parameters. For example, the attention monitoring system 4 may receive a set of eye images from detector 2. The attention monitoring system 4 then assesses the eye images to determine whether the reviewer is sufficiently attentive. The assessment may include a determination as to whether the user's eye is closed or looking away from the display 6. Based on the assessment, the attention monitoring system 4 generates attentiveness data. As described, the attentiveness data may be a binary indication of “yes” or “no” to a query of sufficient attentiveness (e.g. recorded 0 or 1 bit). In other cases, the attentiveness data may indicate a level of attentiveness on a scale of attentiveness.

In further variations, the ultrasound image review system 8 will access the attentiveness data generated by the attention monitoring system. The ultrasound image review system may be in communication with the attention monitoring system by way of a cable 10. In other cases, the systems may communicate wirelessly. If the attentiveness data indicates sufficient attentiveness, the ultrasound image review system 8 will display another ultrasound image. In the case of playing an ultrasound cine, the ultrasound image review system 8 will continue to play the cine. In the event that the attentiveness data indicates the user is not sufficiently attentive, the ultrasound image review system may stop the cine play and/or not display a new image to monitor 6.

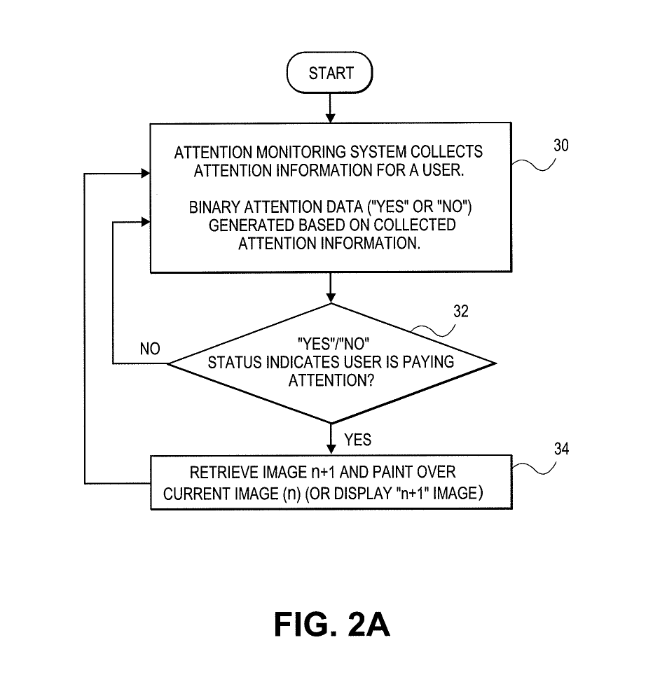

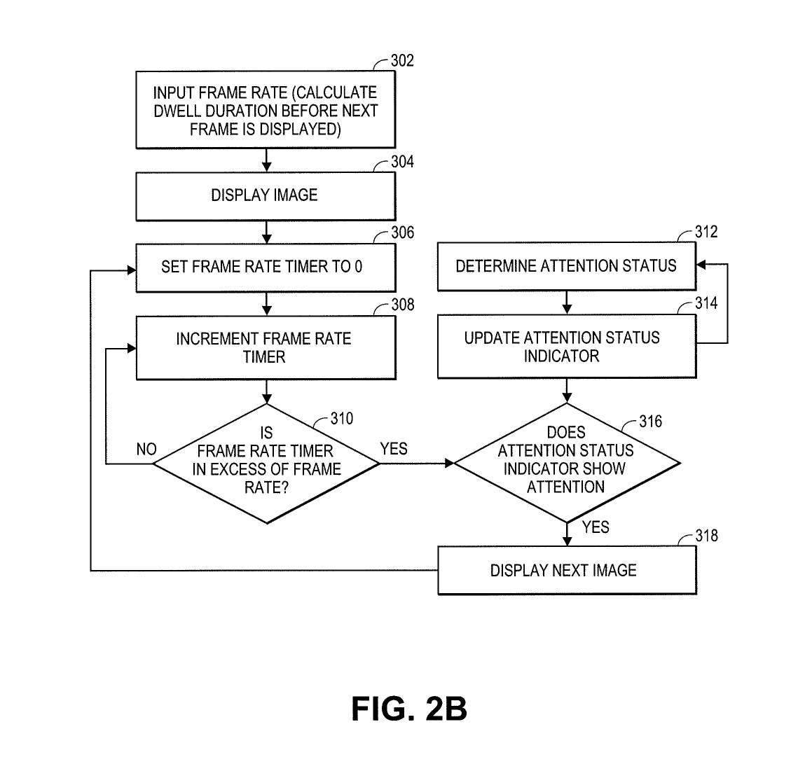

FIG. 2A illustrates an example of a method of accessing attentiveness data. As shown, the attention monitoring system collects attention information for a user reviewing images displayed by the image review system 30. The collected attention information may be assessed by the attention monitoring system to determine whether the user is sufficiently attentive—“yes” or “no” 30. The image review system may query the attention monitoring system regarding the user's attentiveness 32. If the attention data indicates that “yes” the user is sufficiently attentive, the image review system will continue to step 34, which is to retrieve the next image for display. If the attention data includes “no” the user is not sufficiently attentive, the image review system will not advance to step 34. Instead, the image review system may query the attention monitoring system again to determine if subsequent attention data shows “yes” to the query. For example, the attention monitoring system may assess the user's attentiveness multiple times before generating a “yes” result that indicates the user is sufficiently attentive to review images. The user may have momentarily looked away from the display and once the user again is looking in the desired direction, the attention monitoring system will generate attention data indicating sufficient attentiveness for step 34.

The attentiveness assessments may occur at any time during the review process. In some cases, the attention monitoring system is continuously collecting information for the at least one attention parameter and continuously generating attentiveness data. The attentiveness data/status may be updated continuously while the attention monitoring system is operating. In other cases, the attention monitoring system may periodically update the attentiveness data/status based on the information collected for the attention parameter.

In operation, the attention monitoring system may begin collecting attention information and generating attentiveness data before any images are displayed. In such cases, the image review system may not display a first image unless the attentiveness data indicates sufficient attentiveness. The user may select a start option on the image review system which prompts the image review system to check attentiveness data generated and/or stored by the attention monitoring system. If the attentiveness data indicates sufficient attentiveness, the image review system will display the first image. When the image review system is ready to advance to a second image, the image review system will query the attention monitoring system for the attentiveness data/status to determine whether the image review system will display the second images.

As described, the image review system and the attention monitoring system may be separate systems operating independently of one another. The attention monitoring system performs its attention gathering and assessing functions separate from the image review system's output of images to a display. However, the image review system may occasionally access the attention monitoring system to query the user's attentiveness. Based on that query, the image review system may determine whether to display an image to a monitor or display.

Referring to FIG. 2B, another method for reviewing multiple images is shown. As described, the multiple image review system may allow the user to select or input a desired image display rate or frame rate 302. In some cases, this is a frame review rate such as a frame increment rate. This rate may be in frames per second (fps) or may increment at a variable rate so that the presentation to the user represents region reviewed per second (rrps). For example, if the user wishes to review images that would represent a reproduction of the experience that the user would have by scanning at 1 cm/sec, and there were 10 images in the first cm are spaced at 0.0 mm, 1.0 mm, 2.1 mm, 2.9 mm, 4.1 mm, 5.0 mm, 5.9 mm, 6.9 mm, 8.0 mm, 8.8 mm, and 10 mm, then the dwell time for each of these images would be 0.10 sec, 0.11 sec, 0.08 sec, 0.12 sec, 0.09 sec, 0.09 sec, 0.1 sec, 0.11 sec, 0.08 sec, and 0.12 sec. Thus, the first frame would be displayed for 0.01 sec before the screen refreshed with the second frame and the second frame would display for 0.11 sec until the third image is displayed, etc.

In some cases, the multiple image review system computes dwell times or image display times/periods for each image in a series of images for display based on a user defined image display rate. In other cases, the image review system may compute dwell times or image display times/periods based on the scanning distance between images. For example, a series of images representing a 1 cm/sec scan may include a first image scanned at 0.00 mm and a second image scanned at 0.1 mm. The first image and second image have a 0.1 mm scan distance. In computing the dwell times for the images, the image review system may display the first image with a dwell time of 1/10^{th} second based on the scan distance between the first and second images.

As can be appreciated, the scan distance between images in a series of images may not be uniform. As such, the image review system may compute dwell times for each image that are the same or different from one another. For example, a first image may have a 1/10^{th} sec dwell time and a second image may have a 1/100^{th} sec dwell time. Examples of dwell time calculation for images are described in greater detail for similar systems disclosed in commonly assigned International Patent Application No. PCT/US2012/059176, titled Method, Apparatus and System for Complete Examination of Tissue with Hand-Held Imaging Devices filed Oct. 9, 2012, which is herein incorporated by reference in its entirety.

Additionally, the image review system may be configured to display the first image for at least a first image dwell time. Referring back to FIG. 2B, an image is displayed at step 304 once a Frame Rate has been received and a dwell duration for the images for display has been calculated. The Frame Rate timer may be set to zero (306) at the start of when an image is displayed. Once displayed, the Frame Rate timer may be incremented (step 308) to start tracking the display time for the first image. The image review system may check the Frame Rate Timer (step 310) to determine if the tracked time on the Frame Rate Timer coincides with the Frame Rate selected in Step 302. For example, if the Frame Rate selected is 1 cm/sec and the first image is calculated to have a dwell time of 0.1 secs, the image review system may check the Frame Rate Timer at step 310 to determine if 0.1 secs has elapsed. If not, the image review system may look later again to the Frame Rate Timer to determine if the dwell time has elapsed.

If the dwell time has elapsed or been exceeded, the image review system may access the attention status data or information from an attention monitoring system 316. As described, the attention monitoring system gathers attention information for the user and generates attentiveness data and/or an attention status indicator indicating the user's attentiveness. The image review system may periodically access the attentiveness data/status and use this information to determine whether to display the next (e.g. another) image 318 prior to displaying the next image. As shown in FIG. 2B, the attention monitoring system determines attention status 312 and updates the attention status indicator 314. This may be performed continuously and independently of the image review system's operation.

If the attentiveness status indicates sufficient attentiveness, the image review system will output the next image (or second image) to the display and begin timing the duration of the display for the next/second image. The second image may be displayed for at least a second image dwell time that is tracked by the Frame Rate Timer. In some variations, the image review system is configured to access the attentiveness or attention data generated by the attention monitoring system prior to displaying each subsequent image.

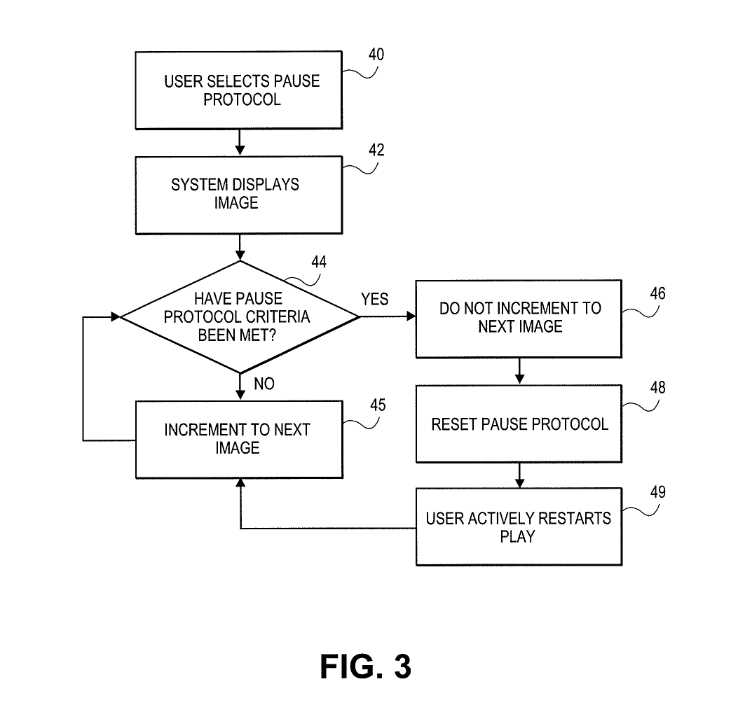

Referring to FIG. 3, another method of assessing attentive information is depicted. As shown, the multiple image review system provides a user input or selection option whereby the user may select to execute a pause protocol 40. Once selected, the multiple image review system proceeds to display an image 42. During or after the display of the image, the system may query whether pause protocol criteria have been met 44. For example, the pause protocol may include the criteria of an attention parameter indicating insufficient attentiveness. The user may have moved away from the display and no longer is gazing at the display monitor. If the pause protocol criteria have not been met, the system increments or displays the next image 45.

If the pause protocol criteria have been met, the system does not advance to the next image 46. Instead, the image display function may be stopped or “paused” 46. As shown, the pause protocol may be reset 48 in some cases where the pause protocol criteria may be subsequently queried to determine if the next image may be shown at that time. Alternatively, the user may actively restart the display or play of images 49.

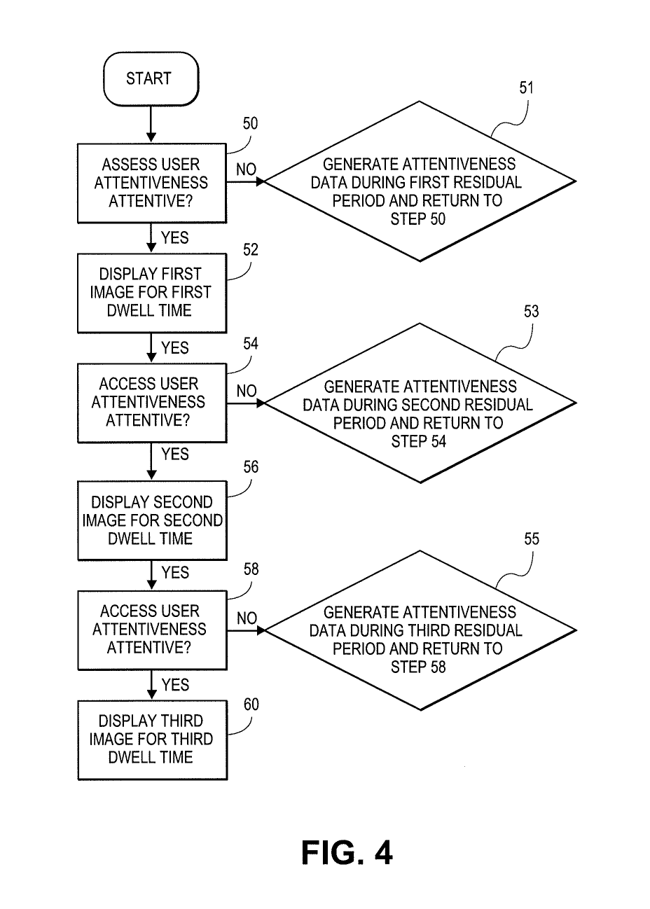

Referring to FIG. 4, the multiple image review system may be configured to access user attentiveness prior to the display of an image. As described, the multiple image review system may include an image review system and an attention monitoring system. The image review system may be configured to output a series of images to a display. The series of images can include any number of images including a first, second, and third image as shown in FIG. 4. Additionally, the user attention monitoring system may be in communication with the image review system to allow the image review system to access attentiveness data generated by the monitoring system. As described, the attention monitoring system may include an attention detector device configured to monitor at least one attention parameter for a user during the user's review images.

Referring to FIG. 4, prior to showing the first image, the image review system may first query whether the user is sufficiently attentive to begin the review 50. The image review system may access attentiveness data generated by the attention monitoring system that indicates the user's level of attentiveness. If the attentiveness data indicates that the user is sufficiently attentive, the image review system is configured to output the first image to the display for a first dwell time or review period 52. If the attentiveness data indicates that the user is not sufficiently attentive, the image review system will reassess attentiveness after a first residual time during which the attention monitoring system will generate attentiveness data for the first residual time or period 51. The residual time/period may provide the user an opportunity become sufficiently attentive to start the review. If the user is sufficiently attentive, the first image will be displayed and review will start. If not, the first residual period will run again along with attention information gathering.

After the first image has been displayed for a first dwell time, image review system queries the attentiveness of the user 54 prior to showing the next or second image. The image review system may access attentiveness status/data generated by an attention monitoring system in communication with the image review system. The attentiveness data may reflect the user's attentiveness based on the most recently collected attention information for the user such as the eye gaze direction etc.

If the attentiveness data indicates the user is sufficiently attentive, the image review system will display the next image or a second image for a second dwell time or second review period 56. If the user is not sufficiently attentive, the multiple image review system will enter a residual period during which the first image continues to be displayed. In some cases, additional attention data is generated during the residual period at step 53. Upon end of the second residual period, the image review system queries the attentiveness of the user. If not sufficient, the system re-enters step 53. If attention is sufficient, the system displays a second image or the next image as shown in step 56.

These described steps are repeated for additional display of images. Step 58 assesses attentiveness before displaying a third image for a third dwell time (step 60). If the user is not sufficiently attentive, the system executes step 55 for further attention information collecting during a third residual period.

In further embodiments, the residual period may correspond to an amount of time predetermined for the user to review the displayed image following detection of insufficient attentiveness. For example, if at the end of the first dwell time, the attention detector detects that the user's eyes were looking away from the display, the attentiveness data would then indicate insufficient attentiveness that triggers step 53. The residual period in step 53 may be a predetermined or user defined period of time that extends the first dwell time with a residual dwell time for the first image, allowing the user to review the first image for a longer display time. Several algorithms may be employed to determine the appropriate residual period be considered minimal for display before the next image is advanced. The human eye can easily see motion with frame rates as high as 64 fps (0.016 ms) and some variations of this device can determine whether the user is sufficiently attentive in as little as 0.007 ms.

During any of the review periods, dwell times, or residual periods/time, the attention monitoring system may be continuously or repeatedly gathering the user's attentiveness information. For example, eye images may be continuously taken during a dwell time. Alternatively, eye images may be taken multiple times during a dwell time.

In other cases, the multiple image review system may include a range of available image display rates such as between about 5 fps to about 64 fps. In further variations, the multiple image review system may dynamically modify the image display rate during the review process according to attentiveness information detected by an attention monitoring device/unit/system. For example, the image review system may be configured to increase the image display rate to a maximum rate of between about 24 fps to about 30 fps or about 40 fps during the review. In some cases, the maximum frame rate is between about 5 fps to about 64 fps. The image review system may incrementally increase the image display rate to the maximum rate if the attentiveness indicates sufficient user attentiveness.

In some cases, the attention monitoring system may query the eye images at timing intervals that are more frequent than the intervals between frame changes. If the eye is closed at the time when a new frame would be displayed, the system will delay advancement to the next frame until the eye is opened and there is sufficient time, as may be defined by the user, for that image to display before the next image is advanced.

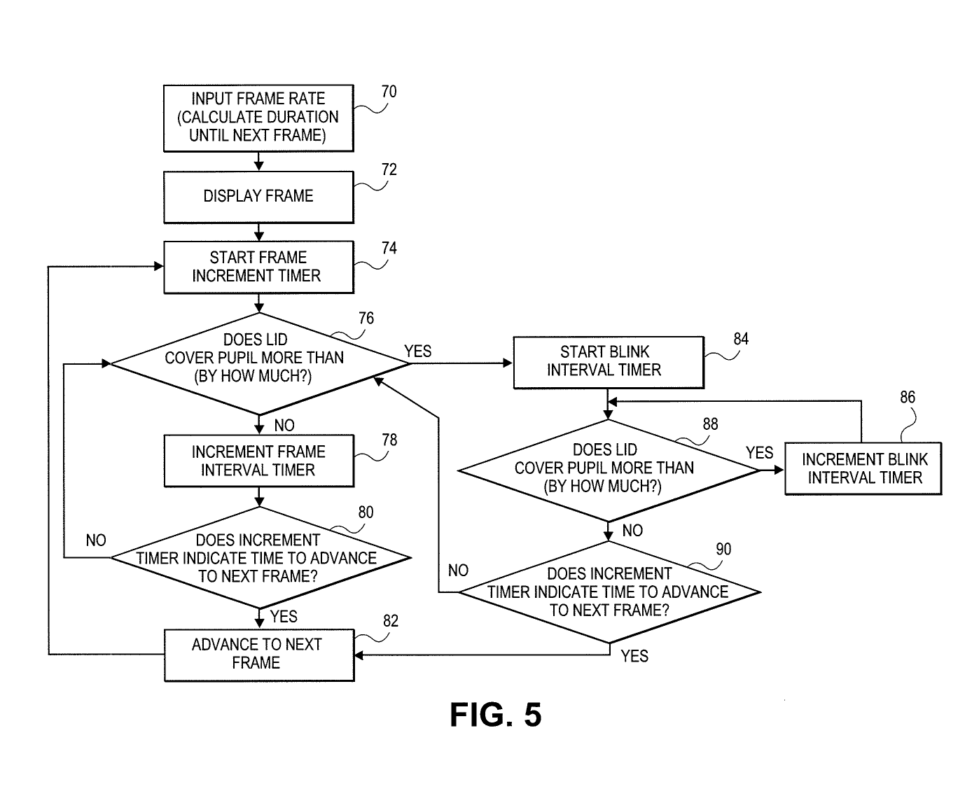

In another aspect, embodiments provide a method of detecting a human eye blink and suspending the sequential presentation process during the period when the eyelid covers the eye. FIG. 5 illustrates an example of this process. In step 70, the user inputs or selects a frame display rate which then may be used to calculate the duration before the next frame (e.g. image dwell time). In step 72, the first frame or image is displayed. When the first frame is displayed, a frame increment timer may be started 74. The frame increment timer may track the display duration of the first image.

Attentiveness data may be assessed during or at the end of the first frame review period. As shown in step 76, the user's eyelid position may be assessed to determine how much of the pupil is covered by the eyelid. In some cases, if the pupil is covered by 50% or more, the system will start a blink interval timer 84. The blink interval timer 84 may track a period of time after which the attention monitoring system will reassess the user's eyelid position 88. If at step 88, the pupil is still covered by 50% or more, the blink interval timer is reset to track another interval before reassessment is performed 86.

If at step 88, the attentiveness data indicates that the user is attentive (e.g. eyelid does not cover the pupil a certain amount), the system will query whether the frame increment timer indicates that it is time to advance to the next frame 90. If yes, the next frame will be displayed 82 and the frame increment timer will start again 74.

if at step 88, the system determines that the frame increment tinier does not indicate time to advance to the next frame, the system will query the attentiveness data at step 76. If the attentiveness data indicates that the user is attentive, the system will query whether the increment timer indicates time to advance to the next frame (steps 78 and 80).

In another aspect, the invention relations to an image review system configured to generate review breaks or distractions during a user's review of images. Introduction of simulated case studies can also have an educational benefit that extends beyond readiness training. Medical training has always been based on the “learn by doing” method. When Hancock, Sime, and others describe how increasing confidence can reduce stress, the underlying message is that in-situ training scenarios increase confidence by making the operator more proficient. Sime suggests that training needs to be provided in conditions that are as similar as possible to the conditions that are likely to be encountered in the real world and that this similarity will improve the likelihood off transfer of training and the maintenance of effective performance.

Incorporating case studies during the normal workflow is one method of providing training which is as close to possible as the real world because it is in the actual real world conditions. In addition, there is the added benefit of time efficiency since adding a 5 min-10 min case study in the normal workflow will result in 17 hours to 33 hours of training during a 200 day work year. That is the equivalent of attending a 2-4 day course, but without the need to travel and the associated expense.

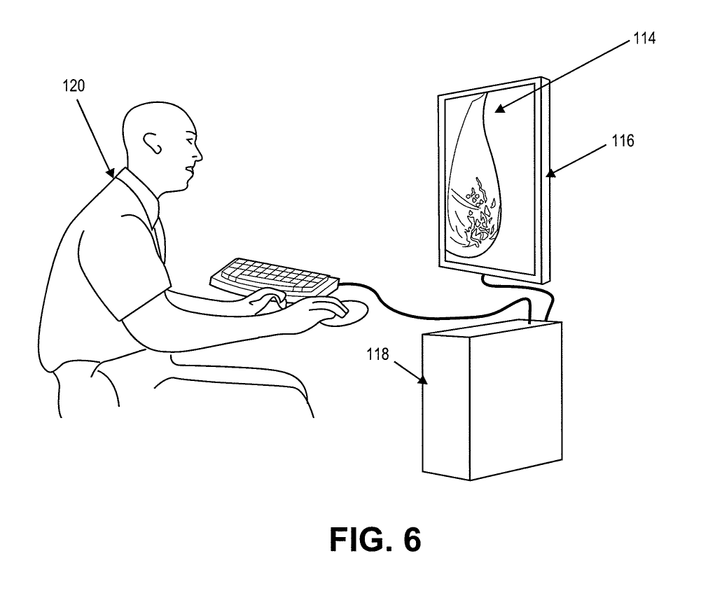

Referring to FIG. 6, in another aspect, the invention relates to a system for reviewing multiple images including a display 116 and an image review system 118 configured to output a series of individual images 114 to the display. The image review system 118 may be configured to generate at least one distraction or review break during a user's 120 review of the images. In some cases the image review system 118 provides frequent distraction breaks during a video presentation. These breaks may force the user to actively re-engage in the review process. In one embodiments, distraction break involves pausing or stopping the video (for example, at the end of a scan track or after a pre-selected period of time) and require an action on the part of the viewer (for example, pressing the “play” button) to re-engage the focused attention process. In other cases, the pause may be for predetermined period of time before resuming display.

Alternatively, the distraction or review break may include intermittent teaching cases inserted within the normal workload of the reviewer. In operation, the reviewer will access the image review system and identify himself/herself. The system can then populate a case worklist from the active patients. In addition, the system can calculate, from a pre-defined user probability protocol, how many teaching cases can be inserted into the normal worklist. The system can also calculate, based on the user profile, how which specific teaching cases have been reviewed by the user and when they were reviewed. The system can access those cases and insert them, randomly, into the worklist.

In operation, the reviewer may review a case with a series of images or a video presentation without knowing if the video presentation is a non-teaching case or a teaching case. For a teaching case, upon completion of the review, the image review system will provide feedback on the reviewer's performance. In the ultrasound diagnostic context, the system may confirm accurate findings by the user of suspicious or cancerous lesions. In other cases, the system may correct the user's findings where the user has made a mistake or missed a finding.

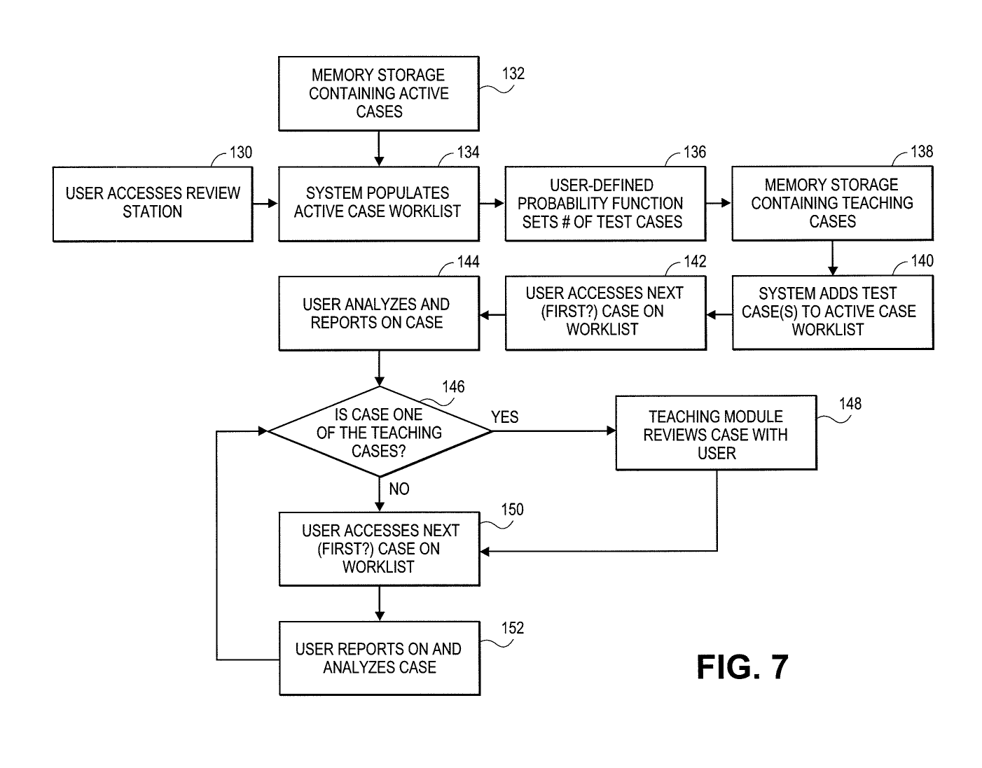

Referring to FIG. 7, user may access the multiple image review system at a review station 130. The multiple image review system may access memory or a storage module that contains active cases (for actual screening or diagnosis by the reviewer) 132. The system populates the active case worklist 134. The user may then input or select a probability function for the number of test cases 136. This allows the system to determine generally how many teaching cases to insert into the case wordlist. At step 138, the system accesses memory storage containing teaching cases. The system then adds the test cases to active case worklist 140.

The user then begins review of a case 142. For the review, the user analyzes and reports on the case 144. Each case may include images or video from a medical scan of a patient. The user reviews the case and images for screening, diagnostic, etc. purposes. Upon completion of analysis and reporting, the system will query whether the case is a teaching case 146. If yes, the system will launch a teaching module to review the case with the user 148. If not a teaching case, the user will access the next case 150. Once the user has analyzed and reported on the case in step 152, the system returns to step 146 to query whether the case is a teaching case.

In some cases, the reviewer will review a set of cases in a worklist sequentially. After completion of a teaching case, however, instead of proceeding to the next case, the system will launch a tutorial to instruct the user on the pertinent aspects of that case. After the tutorial, the system will return to the worklist.

In some embodiments, the distraction break includes stopping or pausing the output of the series of individual images to the display and also presenting a teaching case to the user. In further variations, the image review system accesses a plurality of teaching stored in the image review system or remotely to populate a worklist of teaching cases for the user.

In other embodiments, the teaching breaks in the viewing experience occur periodically such as every 10 seconds to 20 seconds. In further variations, the video material is presented in several short segments; each presented in rapid fashion but interrupted with pauses that allow for short distractions before focused attention is required. The duration of play before a forced pause may be user-selected and may range from 5 sec to 60 sec, or more.

In further embodiments, the system may also include an attention detection device such as those described to monitor a user's attentiveness during review.

As can be appreciated, it is to be understood that other medical images, such as Computed Tomography X-Ray (CT), Magnetic Resonance Imaging (MRI), fluoroscopy, and the like, may also be used in combination with the multiple image review systems, devices, and methods described.

The multiple image review systems described may include computer software instructions or groups of instructions that cause a computer or processor to perform an action(s) and/or to make decisions. In some variations, the system may perform functions or actions such as by functionally equivalent circuits including an analog circuit, a digital signal processor circuit, an application specific integrated circuit (ASIC), or other logic device. In some embodiments, the system includes a processor or controller that performs the reconstruction functions or actions as described. The processor, controller, or computer may execute software or instructions for this purpose.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

What is claimed is:

1. A system for reviewing multiple images comprising:
a display;
a user attention monitoring system configured to detect at least one attention parameter for a user in proximity to the display, wherein the attention monitoring system generates user attention data based on the at least one attention parameter detected; and
an image review system in communication with the attention monitoring system, the image review system configured to output a first image and a second image to the display, and the image review system configured to access the user attention data generated by the attention monitoring system prior to outputting the second image to the display, wherein the image review system outputs the second image to the display if the user attention data indicates sufficient user attentiveness.

2. The system of claim 1, wherein the image review system is configured to output the second image to the display only if the user attention data generated by the attention monitoring system indicates sufficient user attentiveness.

3. The system of claim 1, wherein the image review system is configured to access the user attention data generated by the attention monitoring system prior to outputting the first image to the display, and wherein the image review system is configured to output the first image to the display if the user attention data indicates sufficient user attentiveness.

4. The system of claim 1, wherein the attention monitoring system is configured to detect the at least one attention parameter and generate the user attention data independently of the operation of the image review system.

5. The system of claim 1, wherein the image review system is configured to display the first and second images at an image display rate.

6. The system of claim 5, wherein the image review system is configured to receive the image display rate as a user input value.

7. The system of claim 5, wherein the image display rate is measured as a region reviewed per second.

8. The system of claim 5, wherein the image display rate is at least 6 frames per second.

9. The system of claim 5, wherein the image review system is configured to calculate a first image dwell time for the first image and a second image dwell time for the second image based on the image display rate.

10. The system of claim 9, wherein the image review system is configured to calculate the first and second image dwell times based on a scan distance between the first and second images.

11. The system of claim 9, wherein the image review system is configured to display the first image for at least the first image dwell time and the second image for at least the second image dwell time.

12. The system of claim 1, wherein the image review system is configured to display the first image for a first dwell time and the second image for a second dwell time.

13. The system of claim 12, wherein the image review system is configured to access the user attention data generated by the attention monitoring system prior to displaying the second image for a second dwell time.

14. The system of claim 12, wherein the image review system is configured to display the first image for a residual display period prior to displaying the second image.

15. The system of claim 1, wherein the attention monitoring system comprises an attention detection device configured to detect the at least one attention parameter for the user.

16. The system of claim 1, wherein the attention monitoring system comprises a controller configured to generate the user attention data based on the at least one attention parameter detected.

17. The system of claim 1, wherein the attention monitoring system is configured to continuously detect the at least one attention parameter for the user during the multiple image review.

18. The system of claim 1, wherein the image review system is configured to dynamically increase an image display rate for a series of images output to the display based on the user attention data.

19. The system of claim 1, wherein the at least one attention parameter comprises an ocular parameter.

20. The system of claim 19, wherein the ocular parameter comprises eye gaze direction.

21. The system of claim 19, wherein the ocular parameter comprises eye closure.

22. The system of claim 19, wherein the ocular parameter comprises eye movement.

23. The system of claim 1, wherein the at least one attention parameter comprises head position.

24. The system of claim 1, wherein the at least one attention parameter comprises brain wave activity.

25. A system for reviewing multiple images comprising:
a display; and
an image review system configured to output a series of individual images to the display, wherein the image review system is configured to generate at least one distraction break during a user's review of the series of image on the display.

26. The system of claim 25, wherein the at least one distraction break comprises stopping the output of the series of individual images to the display.

27. The system of claim 25, wherein the at least one distraction break comprises pausing the output of the series of individual images to the display and presentation of a teaching case to the user.

28. The system of claim 25, wherein the image review system comprises a plurality of stored teaching cases and the image review system is configured to populate a worklist of teaching cases for presentation to the user during the user's review of the series of individual images.

29. The system of claim 28, wherein the at least one distraction break comprises presenting at least one teach case from the worklist of teaching cases to the user during the user's review of the series of individual images.

30. The system of claim 25 further comprising an attention detector device configured to monitor at least one user attention parameter during the user's review of the series of individual images.

31. A method of displaying multiple images comprising:
detecting at least one user attention parameter for a user with a user attention monitoring system;
generating user attention data with the user attention monitoring system based on the at least one user attention parameter;
displaying a first image stored in an image review system on the display; and
electronically accessing the generated user attention data by the image review system prior to displaying a second image stored in the image review system on the display, wherein the second image is displayed on the display if the accessed user attention data indicates sufficient user attentiveness.

32. The method of claim 31 further comprising:
receiving a frame rate; and
calculating a first image dwell duration for the first image and a second image dwell duration based for the second image based on the received frame rate; and
displaying the first image on the display for the first image dwell duration.

33. The method of claim 32, wherein the electronically accessing step occurs after the end of the first image dwell duration.

34. The method of claim 31 further comprising:
electronically accessing the generated user attention data by the image review system prior to displaying the first image stored in the image review system on the display, wherein the first image is displayed on the display if the accessed user attention data indicates sufficient user attentiveness.

35. The method of claim 31, wherein the detecting and generating steps are continuously performed independent of the displaying step.

36. The method of claim 31 further comprising displaying the first image on the display for a residual period after the end of the first image dwell duration.

37. The method of claim 31, wherein the electronically accessing step comprising querying the user attention monitoring system for an attention status indicator, and wherein the second image is displayed on the display if the attention status indicator indicators sufficient user attentiveness.

38. The method of claim 31 further comprising querying the user attention monitoring system more than once for an attention status indicator prior to displaying the second image to the display.

39. The method of claim 31 further comprising:
receiving an image display rate for a plurality of images, wherein the plurality of images comprises at least the first image and the second image; and
computing a dwell time for each image of the plurality of images based on the image display rate and scan distances images in the plurality of images.

40. The method of claim 39, wherein the image displayed rate is a region reviewed per second rate.

41. A method for reviewing multiple images comprising:
displaying a series of individual images on a display;
generating at least one distraction break by a controller configured generate the at least one distraction break during the display step.

42. The method of claim 41, wherein the at least one distraction step comprises pausing the display step and presenting a teaching case on the display.

43. The method of claim 41, wherein the at least on distraction step comprises automatically pausing the display step at a predetermined period of time.

44. The method of claim 41, further comprising:
generating a case worklist from a plurality of teaching cases stored in a controller;
presenting at least one case in the case worklist to the user on the display; and
presenting teaching points to the user on the display for the at least one case presented to the user.
